(19) United States
(12) Patent Application Publication
(10) Pub. No.: US 2012/0296631 A1
(43) Pub. Date: Nov. 22, 2012

(54) DISPLAYING KEY PINYINS

(75) Inventors: FANG ZHANG, BEIJING (CN); MINGQIN LI, BEIJING (CN)

(73) Assignee: MICROSOFT CORPORATION, REDMOND, WA (US)

(21) Appl. No.: 13/233,099

(22) Filed: Sep. 15, 2011

(30) Foreign Application Priority Data
May 20, 2011 (CN) PCT/CN2011/074394

(51) Int. Cl. G06F 17/28

(52) U.S. Cl. 704/3; 704/E11.001

(57) ABSTRACT

Methods, systems, devices, and computer-storage media having computer-usable instructions embodied thereon, for displaying key pinyins are provided. Pinyins are words and/or symbols that represent a pronunciation of a character. The character may be a Chinese character. A single page of a user interface of a device may display dynamic updates of key pinyins that are associated with a desired pinyin and dynamic updates of one or more characters that are associated with a desired pinyin. Additional embodiments may provide the associated pinyins and/or characters in a single page that is scrollable at varying speeds depending on a received gesture.

### CROSS-REFERENCE TO RELATED APPLICATIONS

This application claims priority to PCT Application PCT/CN2011/074394, filed May 20, 2011 and titled “Displaying Key Pinyins,” attorney docket number 333101.01/MFCP.162462, the disclosure of which is hereby incorporated herein in its entirety by reference.

### BACKGROUND

An input method editor (IME) allows users to enter symbols or characters that are not typically found on input devices. This is useful in entering, among other things, pinyins, which are letters representing a pronunciation corresponding to a Chinese character. A user can enter pinyins and one or more Chinese characters that correspond with the pinyin are typically displayed to a user. To input pinyins today, a Chinese twelve key IME is typically used. The Chinese twelve key IME includes three or four pinyin characters associated with each single key. A user may input a pinyin to filter Chinese character candidates in order to narrow the scope of the Chinese characters displayed. Typically, a list of all valid pinyins for a syllable of a word, a pinyin filter, is displayed in a page-based style. This is not convenient for users as the list is typically too long to show in a single page, which results in the user being required to view several pages individually to see the options. Additionally, users are not able to view a list of characters until the expected pinyin has been entered.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to systems, methods, devices, and computer storage media for, among other things, displaying key pinyins. A pinyin, as used herein, refers generally to a symbol that represents a pronunciation of a character. In an embodiment, the character is a Chinese character. Pinyins that are associated with an entered pinyin may be displayed in a list within a single page of a user interface. The list may be sorted by frequently used pinyins, commonly selected pinyins, user history, or the like. The list may be dynamic in that it updates as a user inputs a pinyin. The list is also presented in a single page of a user interface such that a user may simply scroll through the single page to view the associated pinyins. Users may select a corresponding pinyin or a corresponding Chinese character at any point before, during, or after inputting a pinyin.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram that illustrates an environment for displaying key pinyins, in accordance with an embodiment of the present invention;

FIG. 3 is an illustrative screen display showing key pinyins and characters for a desired pinyin, in accordance with an embodiment of the present invention;

FIG. 4 is an illustrative screen display showing an expanded view of associated characters for a desired pinyin, in accordance with an embodiment of the present invention;

FIG. 5 is a flow diagram showing a method for displaying key pinyins, in accordance with an embodiment of the present invention; and

FIG. 6 is a flow diagram showing a method for displaying key pinyins, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to systems, methods, devices, and computer storage media for, among other things, displaying key pinyins associated with, for example, Chinese characters. Pinyins that correspond to an entered pinyin (entered by, for example, a user) may be displayed in a list within a single page of a user interface of, for example, a mobile device. The list may be sorted by frequently used pinyins, commonly selected pinyins, user history, or the like. The list may be dynamic in that it updates as a user inputs a pinyin. The list is also presented in a single page of a user interface such that a user may simply scroll through the single page to view the associated pinyins. Users may select a corresponding pinyin or a corresponding Chinese character at any point before, during, or after inputting a pinyin.

Accordingly, one embodiment of the present invention is directed to one or more computer storage media storing computer-useable instructions that, when used by one or more computing devices, cause the computing device to perform a method for displaying key pinyins. The method comprises receiving an input of at least a portion of a pinyin representing a pronunciation of a character. Based on the portion of the pinyin that was input, displaying both a list of one or more pinyins that correspond with the at least a portion of the pinyin that was input and one or more characters that are associated with the at least a portion of the pinyin that was input. Additional input of a second portion of the pinyin is received and the list of one or more pinyins and the one or more characters are updated based on the additional input.

A mobile device configured to present a user interface for displaying key pinyins via a touch input device, the mobile device comprising

Another embodiment of the present invention is directed to a mobile device configured to present a user interface for displaying key pinyins via a touch input device. The device includes a processor, a memory, and a display engine that receives a selection of an expansion indicator, where the selection of the expansion indicator navigates a user to an expanded view including a plurality of characters associated with an input pinyin representing a pronunciation of at least one of the plurality of characters; upon receiving the selection of the expansion indicator, display the expanded view including the plurality of characters such that each of the plurality of characters is accessible within a single page; receive a gesture indicating one of a fast scroll or a slow scroll with which to search the expanded view; and, upon receiving the gesture, display a scrolling view of the expanded view at a rate indicated by the gesture.

Yet another embodiment of the present invention is directed to one or more computer storage media storing computer-useable instructions that, when used by one or more computing devices, cause the computing device to perform a method for displaying key pinyins. The method comprises receiving an input of at least a portion of a pinyin representing a pronunciation of a character. Based on the at least a portion of the pinyin that was input, the at least a portion of the pinyin that was input is displayed along with a list of one or more pinyins that correspond with the at least a portion of the pinyin that was input and a filtered view of one or more characters that are associated with the at least a portion of the pinyin that was input. Additional input of a second portion of the pinyin is received and the list of one or more pinyins and the filtered view of the one or more characters are updated based on the additional input. A selection of an expansion indicator is received where selection thereof navigates a user to an expanded view of the one or more characters that are associated with the input pinyin. Upon receiving the selection of the expansion indicator, each of the input pinyin, including the second portion of the pinyin, the expanded view of the one or more characters that are associated with the input pinyin, and the list of one or more pinyins corresponding with the input pinyin are displayed. A gesture is received that indicates one of a fast scroll or a slow scroll, where the fast scroll navigates through the expanded view faster than the slow scroll and upon receiving the gesture, displaying a scrolling view of the expanded view at a rate indicated by the gesture.

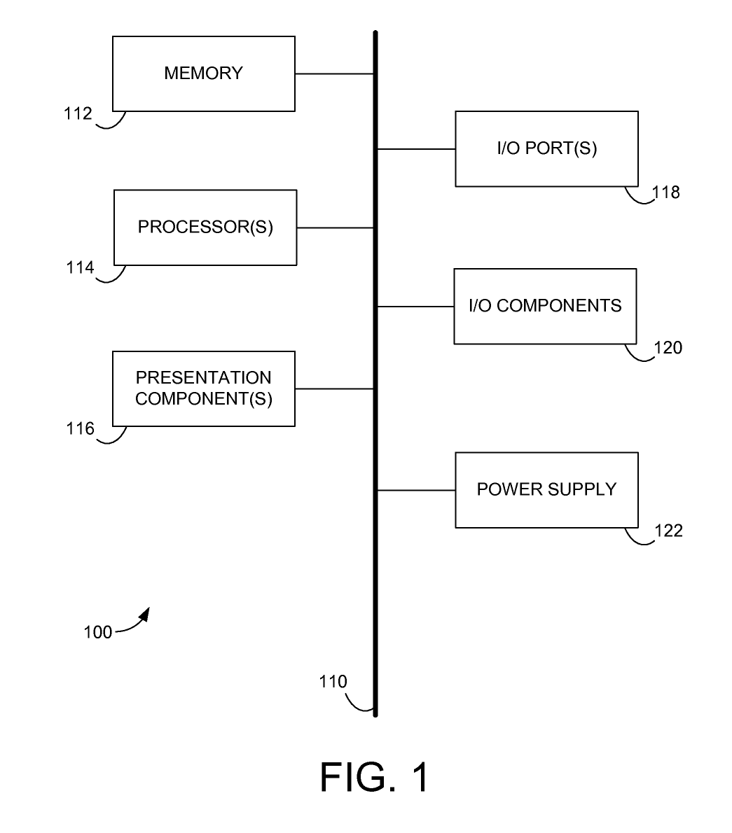

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output (I/O) ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

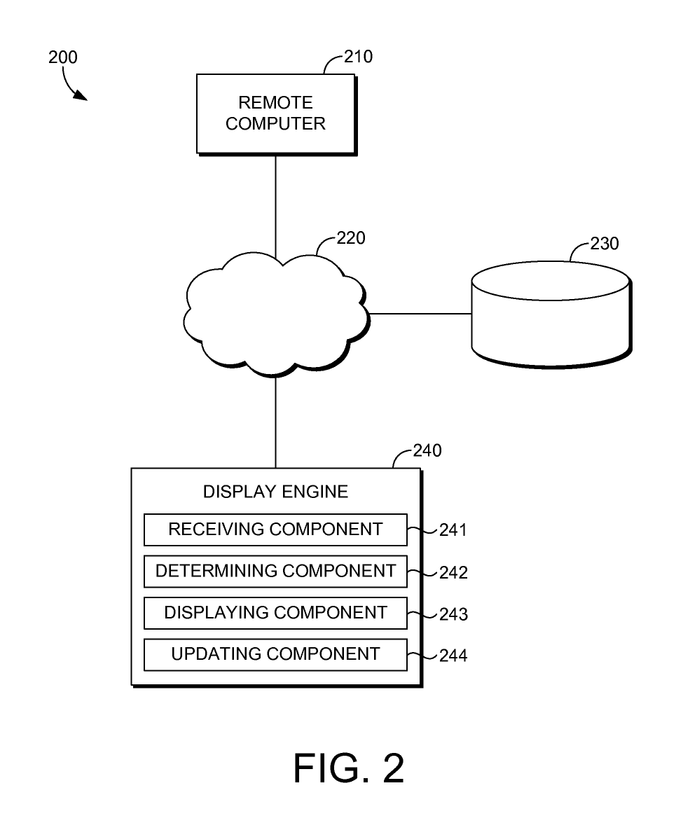

As indicated previously, embodiments of the present invention are directed to displaying key pinyins. Turning now to FIG. 2, an environment 200 for displaying key pinyins is provided, in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the computing system 200 generally includes a remote computing device 210, a network 220, a data store 230, and a display engine 240. The remote computing device 210 may include any type of computing device, such as the computing device 100 described with reference to FIG. 1, for example. The display engine 240 may take the form of a dedicated device for performing the functions described below, may be integrated into, e.g., the remote computing device 210, a network access device, a search engine, a server, a mobile device such as, for example, a mobile phone, or the like, or any combination thereof. The components of the computing system 200 may communicate with each other via the network 220, which may include, without limitation, one or more local area networks (LANs) and/or wide area networks (WANs). Such networking environments are commonplace in offices, enterprise-wide computer networks, intranets and the Internet. It should be understood that any number of computing devices and ranking engines may be employed in the computing system 200 within the scope of embodiments of the present invention. Each may comprise a single device/interface or multiple devices/interfaces cooperating in a distributed environment. For instance, the display engine 240 may comprise multiple devices and/or modules arranged in a distributed environment that collectively provide the functionality of the display engine 240 described herein. Additionally, other components/modules not shown may also be included within the computing system 200.

In some embodiments, one or more of the illustrated components/modules may be implemented as stand-alone applications. In other embodiments, one or more of the illustrated components/modules may be implemented via the display engine 240, as an Internet-based service, or as a module inside a search engine. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

Generally, the computing system 200 illustrates an environment in which key pinyins are displayed to a user. As will be described in further detail below, embodiments of the present invention provide displaying key pinyins to a user while a user is typing a pinyin and dynamically updating a list of key pinyins based on a user input. Additional embodiments provide displaying key pinyins in a single page such that a gesture allows a user to view key pinyins without navigating to a separate page for additional pinyins.

The display engine 240 is configured to display key pinyins to a user. A pinyin, as previously mentioned, refers generally to a representation of a pronunciation of a character. In embodiments, the character is a Chinese character. Put simply, pinyins allow users to type a pronunciation of a Chinese character in order to easily locate the Chinese character. The pinyins may be input using the western alphabet (i.e., the letters A through Z). Exemplary pinyins include, but are not limited to, “qian,” “qiao,” and “shan.”

Key pinyins, as used herein, refers generally to a plurality of pinyins that correspond with an entered pinyin. For instance, corresponding pinyins may have the same spelling as an entered pinyin, have the same pronunciation as the entered pinyin, be commonly selected pinyins when the entered pinyin is identified, or the like.

With continued reference to FIG. 2, the display engine 240 includes a receiving component 241, a determining component 242, a displaying component 243, and an updating component 244. Each of the components is configured to enable to the display engine 240 to display key pinyins.

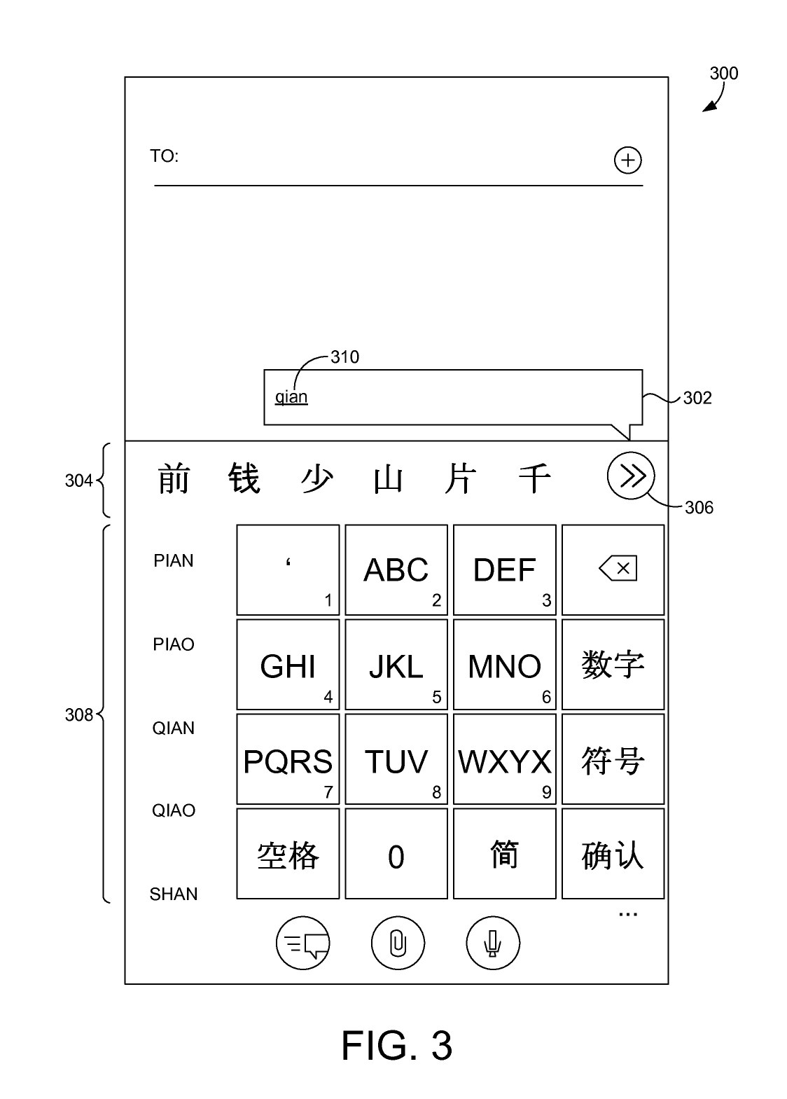

The receiving component 241 is configured to, among other things, receive user inputs of pinyins. As indicated in an exemplary user interface 300 of FIG. 3, an input area 302 is configured such that a user may input a pinyin. The pinyin may be received and identified by, for example, the receiving component 241 of FIG. 2.

The receiving component 241 is further configured to receive a selection of a pinyin and/or a character. As previously explained, a user may input a pinyin in order to locate a corresponding pinyin and/or character. The receiving component 241 may receive a user input of a pinyin (from the input area 302 of FIG. 3, for example) and, subsequently, receive a user selection of a pinyin that corresponds to the user input. For instance, a user may begin typing a user input of a pinyin and quickly identify the desired pinyin in a list presented on a device user interface. Rather than continuing to type the desired pinyin, a user can simply select the desired pinyin from a list of corresponding pinyins. Alternatively, a user may, either while typing a pinyin or after completion of typing the pinyin, identify a desired character that is associated with the entered pinyin.

The determining component 242 is configured to, among other things, determine which pinyins and characters to display in response to the receiving component 241 receiving an input of a desired pinyin. A list of corresponding pinyins may be displayed to a user once a user begins to type a desired pinyin. The list of corresponding pinyins may include pinyins that are spelled the same, or similar, as the desired pinyin, pinyins that have the same, or a similar, pronunciation as the desired pinyin, pinyins that are frequently used, pinyins that are frequently selected when the desired pinyin is input, and the like.

Additionally, a list of corresponding characters (e.g., Chinese characters) may also be displayed to a user in response to a user input of a desired pinyin. The corresponding characters may include characters that are associated with the desired pinyin, characters that are commonly selected when the desired pinyin is entered, frequently used characters, and the like.

By way of example only, FIG. 3 illustrates a candidate window 304 and a pinyin candidate area 308. The candidate window 304 is configured to display one or more characters that are associated with a desired pinyin 310. Similarly, the pinyin candidate area 308 is configured to display one or more pinyins that correspond to the desired pinyin 310.

In an embodiment, a user is able to view the list of corresponding pinyins and the corresponding characters while the user is typing a desired pinyin. This allows a user to select a pinyin and/or character prior to completion of typing the desired pinyin.

Returning to FIG. 2, the displaying component 243 is configured to, among other things, display the determined corresponding pinyins and/or characters. In an embodiment, a desired pinyin, a list or corresponding pinyins, and one or more characters associated with the desired pinyin are simultaneously displayed. This is illustrated in FIG. 3 where the desired pinyin 310, the candidate window 304, and the pinyin candidate area 308 are simultaneously displayed to a user while a user is typing the desired pinyin 310.

The updating component 244 is configured to, among other things, update the determined corresponding pinyins and/or characters based on a user input of a desired pinyin. The determined corresponding pinyins and/or characters are displayed to a user on a dynamic user interface such that the updating component 244 updates the displayed pinyins and/or characters to correspond with the user input as it changes. For instance, a user may input “qia” into an input area of a user interface. The list of corresponding pinyins and one or more associated characters is determined based on the spelling and/or sound of “qia.” Should a user continue to type an “n” into the input area, resulting in “qian,” the list of corresponding pinyins and one or more associated characters is updated based on the updated user input.

In application, in the embodiment illustrated in FIG. 2, a user may enter a desired pinyin into an input area, such as input area 302 of FIG. 3. In FIG. 3, the user has input “qian” as at least a portion of a desired pinyin 310. As a result of the user inputting the desired pinyin 310, the user interface 300 simultaneously displays both a candidate window 304 and a pinyin candidate area 308. The candidate window 304 and the pinyin candidate area 308 may be displayed to a user while the user is typing the desired pinyin 310 such that a user is able to view the candidate window 304 and the pinyin candidate area 308 while the user is still typing (i.e., prior to completion of typing the desired pinyin).

The pinyin candidate area 308 may include one or more pinyins that correspond to the desired pinyin 310. As previously indicated, the one or more pinyins that correspond to the desired pinyin may be spelled the same or similar to the desired pinyin, may sound the same or similar to the desired pinyin, may be frequently selected based upon the input of the desired pinyin, and the like. In an embodiment, a user may select a pinyin from the pinyin candidate area 308 rather than typing the entire pinyin. For instance, if a user had typed “qia” into the input area 302 and the pinyin candidate area 308, as a result, included “qian” as one of the one or more pinyins that correspond to the input, a user may, if desired, select “qian” from the pinyin candidate area 308 rather than typing the “n” to complete the input. By way of further example, if a user had typed “qiang” into an input area, the pinyin candidate area 308 may include a listing of “qiang,” “shang,” “pian,” “piao,” “qiao,” “shan,” “shao,” “qia,” “sha,” “pi,” “qi,” “ri,” “si,” “p,” “q,” “r,” and “c.”

The candidate window 304 may include one or more characters that are associated with the desired pinyin 310. The one or more characters may be determined based on the desired pinyin, a frequency of use of the character, how often the character is selected in combination with the desired pinyin, and the like.

The candidate window 304 may also include an expansion indicator 306. The expansion indicator 306 is configured such that upon selection thereof a user is navigated to a complete listing of characters associated with the desired pinyin 310. For instance, the candidate window 304 of FIG. 3 includes six (6) characters that correspond with the desired pinyin 310. The character that a user wishes to select may not be present in the candidate window 304. The user may then select the expansion indicator 306 to view additional characters associated with the desired pinyin 310.

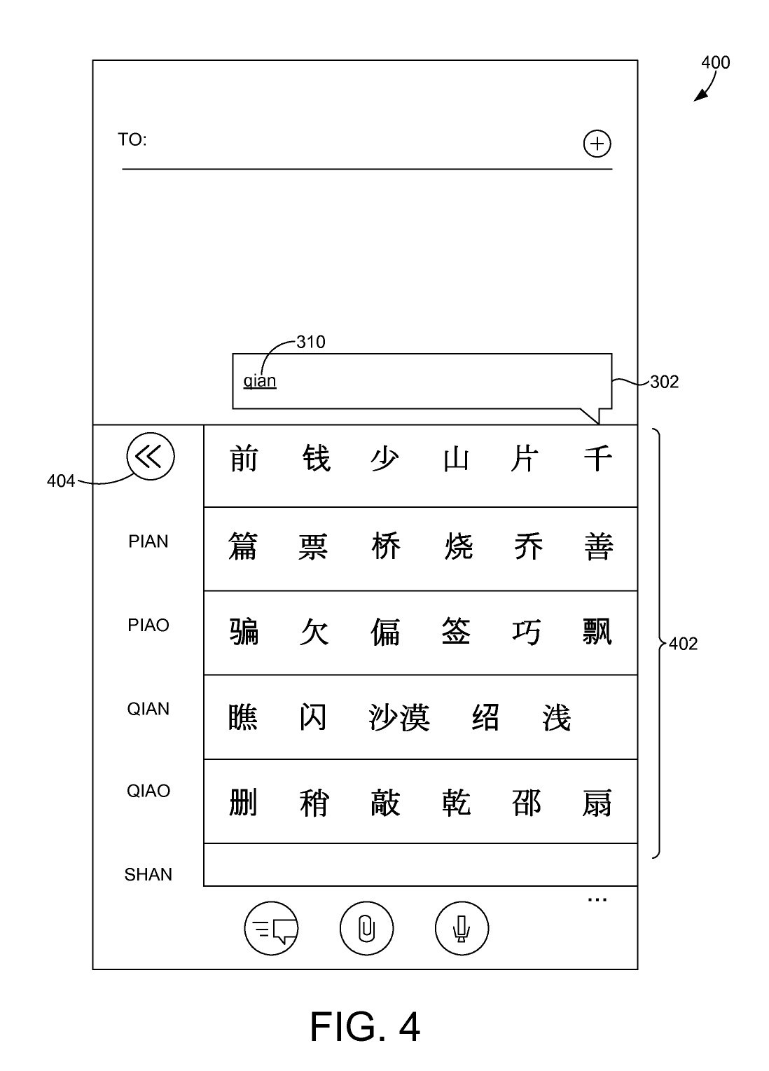

FIG. 4 illustrates a user interface 400 that includes an expanded window 402. The expanded window 402 includes additional characters associated with the desired pinyin 310. The user interface further includes a reverse expansion indicator 404 that, upon selection thereof, navigates a user to a condensed user interface, as seen in FIG. 3.

The expanded window 402 includes each character that is associated with the desired pinyin 310 in a single page. Thus, a user is not required to review several pages to see all options. Rather, a user can simply review a single page of characters. As is evident from FIG. 4, there may be situations where each character associated with a desired pinyin will not fit into the user interface. In this situation, each character associated with the desired pinyin remains on a single page that is searchable at different speeds using gestures. Gestures, as used herein, refer generally to a physical motion of a user that is received by a device. Some exemplary gestures include shaking a device, scrolling a user interface of a device with a user's finger, tapping the user interface of a device with a user's finger, and the like.

Different gestures may be used to control a speed of searching the single page of characters. For instance, a gesture may be associated with a fast scroll while another gesture may be associated with a slow scroll. In an embodiment, a fast scroll is associated with a flick gesture and a slow scroll is associated with a pan gesture. A flick gesture, as used herein, refers generally to a quick, linear movement that may be executed by, for example, a finger or a user input device such as a stylus. A pan gesture, in contrast, is a slower movement that may be executed by, for example, a finger or a user input device such as a stylus. A user is able to simply control the speed with which they move their finger, or stylus, in order to control the speed of the page scroll. As such, a single page of characters associated with a desired pinyin may be searched at different speeds depending on an identified gesture.

As indicated above, the candidate window 304 includes six (6) characters that are associated with the desired pinyin 310. The six characters may be present in the candidate window 304 based on various criteria. For instance, the candidate window 304 may display the most commonly selected characters for the desired pinyin. In an alternative embodiment, the candidate window 304 displays characters associated with common words based on the desired pinyin.

Once a user selects a character, whether from the candidate window 304 of FIG. 3 or from the expanded window 402 of FIG. 4, the selected character may be displayed in the input area 302. As indicated in FIG. 3, the desired pinyin 310 is underlined as it is a temporary input. Thus, once the selected character is displayed in the input area 302, the selected character will not be underlined. The temporary nature of a desired pinyin may be represented in any way and is not limited to underlining the temporary text.

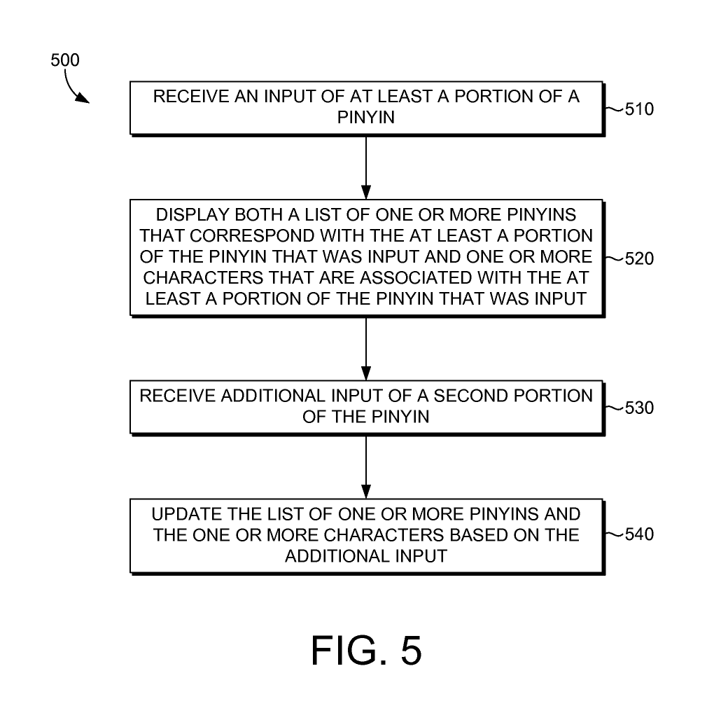

Referring now to FIG. 5, a flow diagram is provided that illustrates an overall method 500 for displaying key pinyins, in accordance with an embodiment of the present invention. Initially, as shown at block 510, an input of at least a portion of a pinyin is received. At block 520, both a list of one or more pinyins that correspond with the at least a portion of the pinyin and one or more characters that are associated with the at least a portion of the pinyin are displayed. At block 530, additional input of a second portion of the pinyin is received and, at block 540, the list of one or more pinyins and the one or more characters is updated based on the additional input.

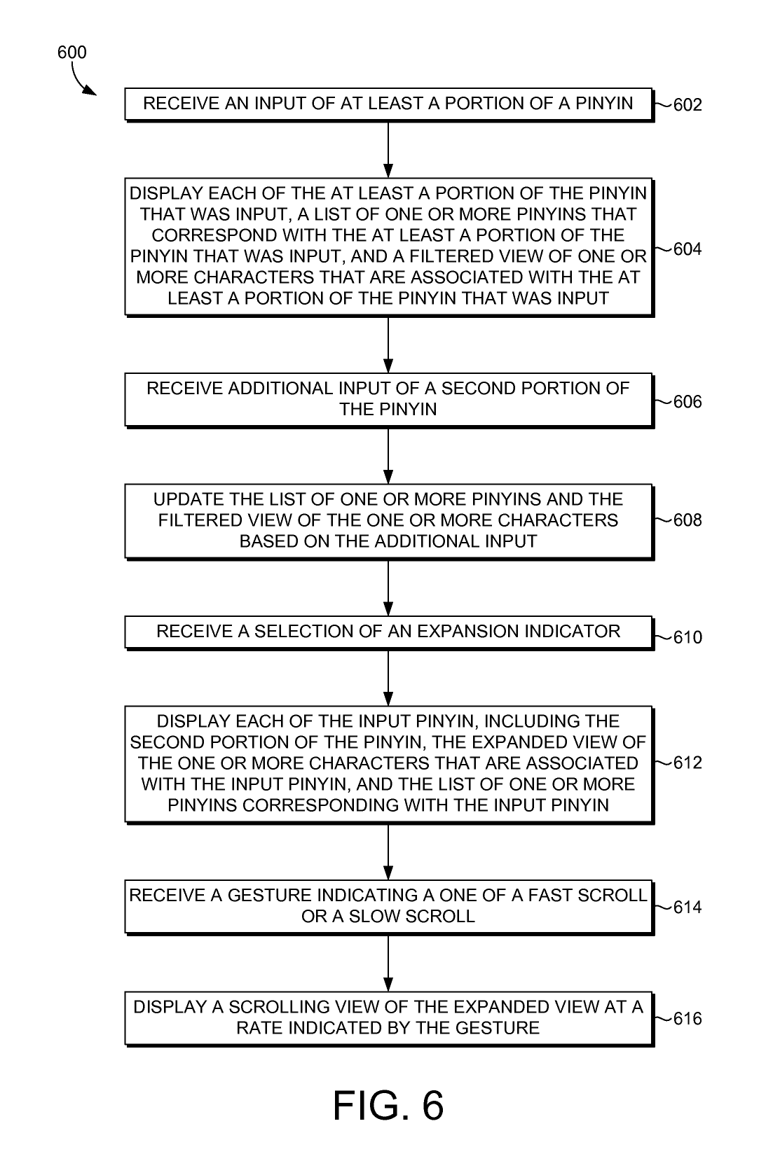

Referring now to FIG. 6, a flow diagram is provided that illustrates an overall method 600 for displaying key pinyins, in accordance with an embodiment of the present invention. Initially, as shown at block 602, an input of at least a portion of a pinyin is received. At block 604, each of the at least a portion of the pinyin, a list of one or more pinyins that correspond with the at least a portion of the pinyin, and a filtered view of one or more characters that are associated with the at least a portion of the pinyin are displayed. At block 606, additional input of a second portion of the pinyin is received. A second portion of the pinyin, in embodiments, is one or more additional letters that are input to the pinyin. At block 608, the list of one or more pinyins and the filtered view of the one or more characters are updated based on the additional input. At block 610, a selection of an expansion indicator is received. Upon receiving the selection of the expansion indicator, each of the input pinyin, the expanded view of the one or more characters that are associated with the input pinyin, and the list of one or more pinyins corresponding with the input pinyin are displayed at block 612. At block 614, a gesture indicating one of a fast scroll or a slow scroll is received. At block 616, a scrolling view of the expanded view is displayed at a rate indicated by the gesture.

As can be understood, embodiments of the present invention provide systems, methods, and computer-storage media having computer-usable instructions embodied thereon, for displaying key pinyins. Embodiments of the invention may provide a user interface for displaying dynamic updates of key pinyins that are associated with a desired pinyin and dynamic updates of one or more characters that is associated with a desired pinyin. Additional embodiments may provide the associated pinyins and/or characters in a single page that is scrollable at varying speeds depending on a received gesture.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform a method, the method comprising:
receiving an input of at least a portion of a pinyin, wherein a pinyin represents a pronunciation of a character;
based on the at least a portion of the pinyin that was input, displaying both a list of one or more pinyins that correspond with the at least a portion of the pinyin that was input and one or more characters that are associated with the at least a portion of the pinyin that was input;
receiving additional input of a second portion of the pinyin; and
updating the list of one or more pinyins and the one or more characters based on the additional input.

2. The one or more computer storage media of claim 1, wherein the one or more characters are Chinese characters.

3. The one or more computer storage media of claim 1, further comprising receiving a selection of one of the one or more pinyins from the list or the one or more characters.

4. The one or more computer storage media of claim 3, further comprising upon receiving the selection of the one or more characters, displaying the character in place of the input pinyin.

5. The one or more computer storage media of claim 3, further comprising:
receiving a selection of an expansion indicator, wherein the expansion indicator expands the one or more characters that are displayed such that additional characters are displayed in a single page; and
displaying a plurality of characters that are associated with the input pinyin.

6. The one or more computer storage media of claim 1, wherein the one or more pinyins that correspond with the at least a portion of the pinyin that was input and the one or more characters that are associated with the at least a portion of the pinyin that was input are simultaneously displayed while a user is typing the at least a portion of the pinyin.

7. The one or more computer storage media of claim 1, wherein the one or more pinyins that correspond with the at least a portion of the pinyin that was input and the one or more characters that are associated with the at least a portion of the pinyin that was input are simultaneously displayed while a user is reviewing an expanded view of the one or more characters.

8. The one or more computer storage media of claim 7, further comprising receiving a gesture, while displaying the expanded view of the one or more characters, indicating a fast scroll speed or a slow scroll speed to review the expanded view within a single interface.

9. A mobile device configured to present a user interface for displaying key pinyins via a touch input device, the mobile device comprising:
a processor;
a memory; and
a display engine that
receives a selection of an expansion indicator, wherein selection thereof navigates a user to an expanded view including a plurality of characters associated with an input pinyin representing a pronunciation of at least one of the plurality of characters;
upon receiving the selection of the expansion indicator, displays the expanded view including the plurality of characters such that each of the plurality of characters is accessible within a single page;
receives a gesture indicating one of a fast scroll or a slow scroll with which to search the expanded view; and
upon receiving the gesture, displays a scrolling view of the expanded view at a rate indicated by the gesture.

10. The mobile device of claim 9, wherein the gesture indicating a slow scroll is a pan gesture.

11. The mobile device of claim 9, wherein the gesture indicating a fast scroll is a flick gesture.

12. The mobile device of claim 9, wherein the one or more characters are Chinese characters.

13. The mobile device of claim 9, wherein the plurality of characters is associated with the input pinyin.

14. The mobile device of claim 9, wherein the display component is further configured to receive a user selection of one of the plurality of characters.

15. One or more computer storage media storing computer-useable instructions that, when used by one or more computing devices, cause the one or more computing devices to perform a method, the method comprising:
receiving an input of at least a portion of a pinyin, wherein a pinyin represents a pronunciation of a character;
based on the at least a portion of the pinyin that was input, displaying each of the at least a portion of the pinyin that was input, a list of one or more pinyins that correspond with the at least a portion of the pinyin that was input, and a filtered view of one or more characters that are associated with the at least a portion of the pinyin that was input;
receiving additional input of a second portion of the pinyin;
updating the list of one or more pinyins and the filtered view of the one or more characters based on the additional input;
receiving a selection of an expansion indicator, wherein selection thereof navigates a user to an expanded view of the one or more characters that are associated with the input pinyin;
displaying each of the input pinyin, including the second portion of the pinyin, the expanded view of the one or more characters that are associated with the input pinyin, and the list of one or more pinyins corresponding with the input pinyin;
receiving a gesture indicating one of a fast scroll or a slow scroll, wherein the fast scroll navigates through the expanded view faster than the slow scroll; and
upon receiving the gesture, displaying a scrolling view of the expanded view at a rate indicated by the gesture.

16. The one or more computer storage media of claim 15, wherein the filtered view of the one or more characters includes frequently selected characters.

17. The one or more computer storage media of claim 15, wherein the gesture indicating a slow scroll is a pan gesture.

18. The one or more computer storage media of claim 15, wherein the gesture indicating a fast scroll is a flick gesture.

19. The one or more computer storage media of claim 15, further comprising displaying the character selected by the user in a text input box.

20. The one or more computer storage media of claim 19, further comprising:
receiving at least a first portion of a second pinyin such that the text input box displays both the character selected by the user and the first portion of the second pinyin; and
displaying both a second list of one or more pinyins that correspond with the second portion of the second pinyin that was input and a second filtered view of one or more characters that are associated with the second portion of the second pinyin that was input.
